(19) United States
(12) Patent Application Publication
(10) Pub. No.: US 2026/0189826 A1
(43) Pub. Date: Jul. 2, 2026

(54) MICRO ELECTROMECHANICAL LOUDSPEAKER HYBRID SYSTEM

(71) Applicants: ZILL TEK TECHNOLOGY (SHANGHAI) CORP., Shanghai (CN); ZILL TEK TECHNOLOGY CORP., Hsinchu (TW)

(72) Inventors: Jinghua YE, Shanghai (CN); Zhenqi QIU, Shanghai (CN); Zihao YE, Shanghai (CN)

(21) Appl. No.: 19/309,366

(22) Filed: Aug. 25, 2025

(30) Foreign Application Priority Data
Dec. 30, 2024 (CN) 202411954406.3

(51) Int. Cl. H04R 1/02; H04R 1/06; H04R 7/18; H04R 19/02; H04R 29/00

(52) U.S. Cl. CPC H04R 1/025; H04R 1/06; H04R 7/18; H04R 19/02; H04R 29/001; H04R 2201/003

(57) ABSTRACT

The invention relates to the technical field of micro electromechanical systems, in particular to a micro electromechanical loudspeaker hybrid system which comprises an acoustic cavity. The acoustic cavity is provided with: a micro electromechanical loudspeaker; an acoustic sensor, arranged on a substrate which is the same substrate on which the micro electromechanical loudspeaker is arranged; a microprocessor, arranged on the substrate, an input end of the microprocessor is connected with the acoustic sensor, and an output end of the microprocessor is connected with a driving end of the micro electromechanical loudspeaker. According to the micro-electro-mechanical loudspeaker hybrid system, the loudspeaker can be monitored through the acoustic sensor, the sensitivity is better, distortion is overcome, and the loudspeaker is protected.

### FIELD OF THE INVENTION

The present invention relates to the field of micro electromechanical technology, and in particular, to a hybrid system for a micro electromechanical loudspeaker hybrid system.

### DESCRIPTION OF THE RELATED ART

Micro electromechanical loudspeakers are being increasingly applied in consumer electronics and professional audio equipment due to advantages such as miniaturization, reliability, and lightweight. The micro electromechanical loudspeakers in the prior art exhibit insufficient sensitivity, significant distortion, and inability to achieve calibration and protection.

### SUMMARY OF THE INVENTION

Based on the foregoing description, the present invention provides a micro electromechanical loudspeaker hybrid system.

A micro electromechanical loudspeaker hybrid system, comprises an acoustic cavity, the acoustic cavity is provided with:
a micro electromechanical loudspeaker;
an acoustic sensor, arranged on a substrate which is the same substrate on which the micro electromechanical loudspeaker is arranged;
a microprocessor, arranged on the substrate, an input end of the microprocessor is connected with the acoustic sensor, and an output end of the microprocessor is connected with a driving end of the micro electromechanical loudspeaker.

For the micro electromechanical loudspeaker hybrid system of the invention, a metal cover is mounted on the substrate, and the metal cover and the substrate form the acoustic cavity;
the acoustic cavity is further provided with:
a micro electromechanical member, arranged on a first area of the substrate via an adhesive member located below the micro electromechanical member;
a diaphragm, arranged on the micro electromechanical member via a first adhesive film located above the micro electromechanical member.

For the micro electromechanical loudspeaker hybrid system of the invention, the metal cover is provided with a sound hole located on a side wall.

For the micro electromechanical loudspeaker hybrid system of the invention, the first area on the substrate is provided with a through hole, and a mesh electrostatic voice coil is arranged at a bottom of the substrate at a position corresponding to the through hole.

For the micro electromechanical loudspeaker hybrid system of the invention, further comprising a double-sided adhesive tape layer, including a first portion arranged along a border of the diaphragm and a second portion arranged along a border of a backplate.

For the micro electromechanical loudspeaker hybrid system of the invention, a length of the metal cover is 7 mm to 8 mm, and a width of the metal cover is 5 mm to 6 mm.

For the micro electromechanical loudspeaker hybrid system of the invention, a side length of the acoustic sensor is 0.8 mm, a distance between the acoustic sensor and the micro electromechanical loudspeaker is 0.18 mm to 0.275 mm, and a distance between the acoustic sensor and the microprocessor is 0.2 mm.

For the micro electromechanical loudspeaker hybrid system of the invention, the first area is provided with a recess relative to a surface of the substrate, and the micro electromechanical member is arranged within the recess.

For the micro electromechanical loudspeaker hybrid system of the invention, a conductive path is arranged on the substrate to connect the acoustic sensor to the microprocessor and to connect the microprocessor to a drive end of the micro electromechanical loudspeaker.

For the micro electromechanical loudspeaker hybrid system of the invention, the mesh electrostatic voice coil is circular, and the adhesive member is a square frame structure.

The beneficial technical effects are as follows: the micro electromechanical loudspeaker hybrid system of the invention enables monitoring of the speaker through an acoustic sensor, thereby achieving improved sensitivity, overcoming distortion, and protecting the speaker.

### BRIEF DESCRIPTION OF THE DRAWINGS

FIG. 1 is a schematic structural diagram of the present invention;

FIG. 2 is a schematic structural diagram of an embodiment of the present invention;

FIG. 3 is an exploded schematic structural diagram of a micro electromechanical loudspeaker in an embodiment of the present invention.

### CALLOUT LIST OF ELEMENTS

1—Substrate
2—Metal Cover
3—Micro Electromechanical Member
4—Diaphragm
5—Adhesive Member
6—First Adhesive Film
7—Double-Sided Adhesive Tape Layer
8—Mesh Electrostatic Voice Coil
9—Conductive Adhesive
10—Acoustic Sensor
11—Microprocessor
12-—Sound Hole
13—Micro Electromechanical Loudspeaker

### DETAILED DESCRIPTION

The technical solutions in the embodiments of the present invention will be

clearly and completely described below in conjunction with the accompanying drawings in the embodiments of the present invention. It is apparent that the described embodiments are merely a part of the embodiments of the present invention, rather than all of them. All other embodiments obtained by a person of ordinary skill in the art based on the embodiments of the present invention without making creative efforts shall fall within the protection scope of the present invention.

It should be noted that, in the absence of conflict, the embodiments in the present invention and the features in the embodiments may be combined with each other.

The present invention will be further described below in conjunction with the accompanying drawings and specific embodiments, but such description shall not be construed as limiting the invention.

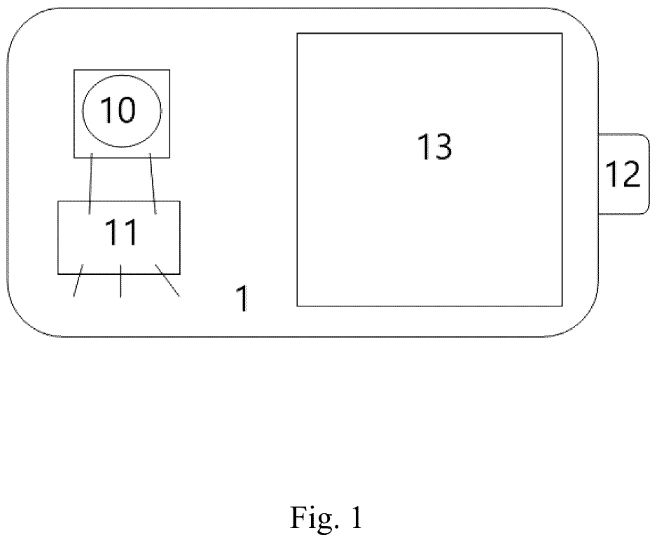

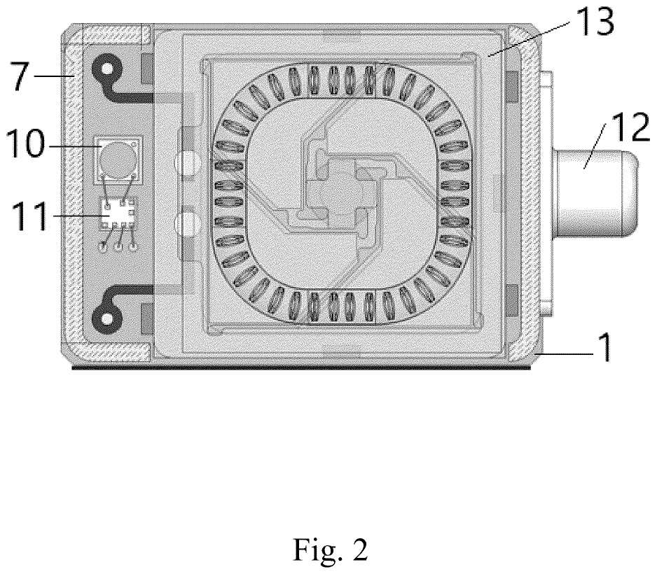

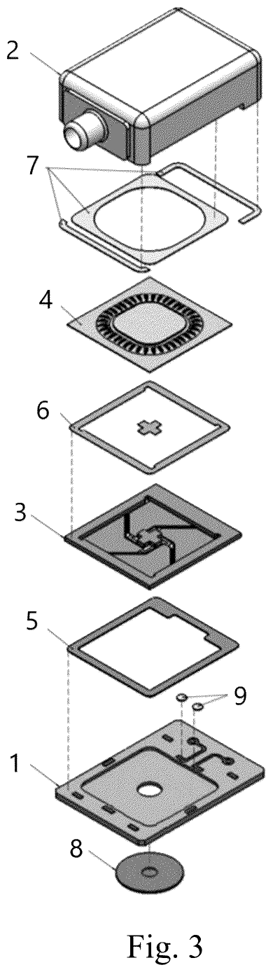

Referring to FIGS. 1 to 3, a micro electromechanical loudspeaker hybrid system, comprises an acoustic cavity, the acoustic cavity is provided with:
a micro electromechanical loudspeaker 13;
an acoustic sensor 10, arranged on a substrate 1 which is the same substrate on which the micro electromechanical loudspeaker is arranged;
a microprocessor 11, arranged on the substrate 1, an input end of the microprocessor 11 is connected with the acoustic sensor 10, and an output end of the microprocessor 11 is connected with a driving end of the micro electromechanical loudspeaker 13.

The present application arranges a micro electromechanical loudspeaker and an acoustic sensor within the same acoustic cavity. The acoustic sensor monitors sound emitted by the micro electromechanical loudspeaker, and a microprocessor acts on the drive end of the micro electromechanical loudspeaker to achieve calibration of the micro electromechanical loudspeaker through a closed-loop path, thereby realizing improved sensitivity, overcoming distortion, and protecting the speaker.

In a preferred embodiment of the invention, a metal cover 2 is mounted on the substrate 1, and the metal cover 2 and the substrate 1 form the acoustic cavity; further comprising,
a micro electromechanical member 3, arranged on a first area of the substrate 1 via an adhesive member 5 located below the micro electromechanical member 3;
a diaphragm 4, arranged on the micro electromechanical member 3 via a first adhesive film 6 located above the micro electromechanical member 3.

For the micro electromechanical loudspeaker hybrid system of the invention, the metal cover 2 is provided with a sound hole 12 located on a side wall.

In a preferred embodiment of the invention, the first area is provided with a recess relative to a surface of the substrate 1, and the micro electromechanical member 3 is arranged within the recess.

In a preferred embodiment of the invention, the adhesive member 5 is a square frame structure.

In a preferred embodiment of the invention, the first area on the substrate 1 is provided with a through hole, and a mesh electrostatic voice coil 8 is arranged at a bottom of the substrate 1 at a position corresponding to the through hole, the mesh electrostatic voice coil 8 is circular.

In a preferred embodiment of the invention, a conductive adhesive 9 is arranged on an area of the substrate 1 for mounting the acoustic sensor 10 and the microprocessor 11. A conductive path is arranged on the substrate to connect the acoustic sensor 10 to the microprocessor 11 and to connect the microprocessor 11 to the drive end of the micro electromechanical loudspeaker 13.

In a preferred embodiment of the invention, further comprising a double-sided adhesive tape layer 7, including a first portion arranged along a border of the diaphragm 4 and a second portion arranged along a border of a backplate.

In a preferred embodiment of the invention, the metal cover is a cuboid structure with a bottom opening, a length of the metal cover 2 is 7 mm to 8 mm, and a width of the metal cover 2 is 5 mm to 6 mm.

In a preferred embodiment of the invention, a side length of the acoustic sensor is 0.8 mm, a distance between the acoustic sensor 10 and the micro electromechanical loudspeaker 13 is 0.18 mm to 0.275 mm, and a distance between the acoustic sensor 10 and the microprocessor 11 is 0.2 mm.

Conventional speakers operate in an open-loop configuration, with the speaker and the acoustic sensor positioned far apart. In the present application, the acoustic sensor and the microprocessor 11 are arranged adjacent to the micro electromechanical loudspeaker 13, thereby reducing transmission delay and improving acoustic characteristics.

Specific embodiments of typical structures are provided through the description and drawings, and other modifications may be made based on the spirit of the present invention. Although the foregoing invention has proposed relatively preferred embodiments of the prior art, these contents are not intended to be limiting.

Various alterations and modifications will undoubtedly become apparent to those skilled in the art after reading the above description. Accordingly, the appended claims should be construed as covering all alterations and modifications that fall within the true intent and scope of the present invention. Any and all equivalents to the scope and content of the claims shall be deemed to remain within the intent and scope of the present invention.

1. A micro electromechanical loudspeaker hybrid system, comprises an acoustic cavity, the acoustic cavity is provided with:
a micro electromechanical loudspeaker;
an acoustic sensor, arranged on a substrate which is the same substrate on which the micro electromechanical loudspeaker is arranged;
a microprocessor, arranged on the substrate, an input end of the microprocessor is connected with the acoustic sensor, and an output end of the microprocessor is connected with a driving end of the micro electromechanical loudspeaker.

2. The micro electromechanical loudspeaker hybrid system of claim 1, wherein a metal cover is mounted on the substrate, and the metal cover and the substrate form the acoustic cavity;
the acoustic cavity is further provided with:
a micro electromechanical member, arranged on a first area of the substrate via an adhesive member located below the micro electromechanical member;
a diaphragm, arranged on the micro electromechanical member via a first adhesive film located above the micro electromechanical member.

3. The micro electromechanical loudspeaker hybrid system of claim 2, wherein the metal cover is provided with a sound hole located on a side wall.

4. The micro electromechanical loudspeaker hybrid system of claim 2, wherein the first area on the substrate is provided with a through hole, and a mesh electrostatic voice coil is arranged at a bottom of the substrate at a position corresponding to the through hole.

5. The micro electromechanical loudspeaker hybrid system of claim 2, further comprising:
a double-sided adhesive tape layer, including a first portion arranged along a border of the diaphragm and a second portion arranged along a border of a backplate.

6. The micro electromechanical loudspeaker hybrid system of claim 2, wherein the metal cover is a cuboid structure with a bottom opening, a length of the metal cover is 7 mm to 8 mm, and a width of the metal cover is 5 mm to 6 mm.

7. The micro electromechanical loudspeaker hybrid system of claim 1, wherein a side length of the acoustic sensor is 0.8 mm, a distance between the acoustic sensor and the micro electromechanical loudspeaker is 0.18 mm to 0.275 mm, and a distance between the acoustic sensor and the microprocessor is 0.2 mm.

8. The micro electromechanical loudspeaker hybrid system of claim 2, wherein the first area is provided with a recess relative to a surface of the substrate, and the micro electromechanical member is arranged within the recess.

9. The micro electromechanical loudspeaker hybrid system of claim 1, wherein a conductive path is arranged on the substrate to connect the acoustic sensor to the microprocessor and to connect the microprocessor to a drive end of the micro electromechanical loudspeaker.

10. The micro electromechanical loudspeaker hybrid system of claim 4, wherein the mesh electrostatic voice coil is circular, and the adhesive member is a square frame structure.
